(19) United States
(12) Patent Application Publication
(10) Pub. No.: US 2012/0098626 A1
(43) Pub. Date: Apr. 26, 2012

(54) DISTRIBUTED CONSTANT CIRCUIT

(75) Inventor: Shimpei Oshima, Tokyo (JP)

(73) Assignee: TAIYO YUDEN CO., LTD., Tokyo (JP)

(21) Appl. No.: 13/262,580

(22) PCT Filed: Mar. 29, 2010
(86) PCT No.: PCT/JP2010/055522

§ 371 Date: Sep. 30, 2011

(30) Foreign Application Priority Data
Apr. 3, 2009 (JP) 2009-090814

(51) Int. Cl. H01P 1/203

(52) U.S. Cl. 333/204

(57) ABSTRACT

A distributed constant circuit includes a plurality of insulator layers including a first insulator layer that contains a first transmission line formed into a rectangular ring of less than one turn, a second insulator layer that contains a second transmission line which is electrically connected to the first transmission line through an inter-layer connection conductor, and which is formed into a rectangular ring of less than one turn, and a third insulator layer containing a ground electrode. In the distributed constant circuit, a rectangular spiral circuit pattern including the first transmission line and the second transmission line is formed by laminating the plurality of insulator layers. The second transmission line includes a side which is located in parallel with at least one side of the first transmission line, the sides parallel with each other are arranged so as not to overlap in the lamination direction of the plurality of the insulator layers, and at least one corner of at least one of the first transmission line and the second transmission line is formed so that the inner circumference and the outer circumference of the corner are concentric circular arcs.

### TECHNICAL FIELD

The present invention relates to a distributed constant circuit, and more particularly, to a distributed constant circuit that can be miniaturized.

### BACKGROUND ART

A distributed constant circuit is used to realize a variety of electronic devices such as resonators and the like. For instance, realization of a bandpass filter used in the Ultra-Wide-Band (hereinafter may be referred to as “UWB”) wireless systems by employing a distributed constant circuit is being investigated. The present inventor has proposed a distributed constant circuit suited for electronic devices utilizing such a wide band in Japanese Patent Application No. 2005-375484 (Published as Japanese Patent Application Laid-Open Publication No. 2007-180781 (Patent Publication 1)).

Miniaturization is desired for a distributed constant circuit that is used in the wireless communication. For example, in Japanese Patent Application Laid-Open Publication No. 2003-168948 (Patent Document 2), miniaturization of the circuit by forming a transmission line in a spiral (essentially a swirl), meander, or saw blade shape on one insulator layer is described.

### RELATED ART DOCUMENTS

### Patent Documents

Patent Document 1: Japanese Patent Application Laid-Open Publication No. 2007-180781

Patent Document 2: Japanese Patent Application Laid-Open Publication No. 2003-168948

### SUMMARY OF THE INVENTION

### Problems to be Solved by the Invention

An object of the present invention is to provide a variety of improvements to a conventional distributed constant circuit. The present inventor has discovered a problem that the likelihood of transmission lines being shorted with each other increases as miniaturization is pursued, because the transmission lines are formed close to each other on a single insulator layer in a conventional miniaturized distributed constant circuit. Also, in the case that a transmission line is formed into a meander shape for miniaturization purpose, the present inventor has found the following problem. Since the electric currents in two transmission lines that are positioned close to each other are flowing in opposite directions with each other, as shown in FIG. 25, the magnetic fields generated by these currents cancel each other and the resonant frequency shifts to a high frequency side and, thus, intended characteristics by design cannot be obtained.

Other than those above, various problems are described throughout the disclosure of the present specification.

### Means for Solving the Problems

A distributed constant circuit in an embodiment has a plurality of insulator layers including a first insulator layer that contains a first transmission line formed into a rectangular ring of less than one turn, a second insulator layer that contains a second transmission line electrically connected to the first transmission line through an inter-layer connection conductor, and formed into a rectangular ring of less than one turn, and a third insulator layer containing a ground electrode, wherein a rectangular spiral circuit pattern including the first transmission line and the second transmission line is formed by laminating the plurality of insulator layers, and wherein the second transmission line includes a side which is located in parallel with at least one side of the first transmission line, the sides parallel with each other are arranged so as not to overlap in the lamination direction of the plurality of the insulator layers, and at least one corner of at least one of the first transmission line and the second transmission line is formed so that an inner circumference and an outer circumference of the corner are concentric circular arcs.

In the distributed constant circuit of that embodiment, since a rectangular spiral round pattern is formed by connecting transmission lines formed in the plurality of insulator layers, when compared with the case where a pattern having the same length is formed in a meander shape on a single insulator layer, a long distance can be secured between the transmission lines having currents flowing in opposing directions. Thus, deterioration of the characteristics due to cancellation of the magnetic fields can be prevented. Also, the second transmission line includes a side which is located in parallel with at least one side of the first transmission line, and the sides positioned parallel with each other are arranged so as not to overlap in the lamination direction of the plurality of the insulator layers. Accordingly, deterioration of the characteristics due to stray capacitances can be prevented.

A filter according to an embodiment has a plurality of insulator layers including a first insulator layer that contains a first transmission line connected to an input terminal and to an output terminal and formed into a rectangular ring of less than one turn, a second insulator layer that contains a second transmission line electrically connected to the first transmission line through an inter-layer connection conductor and formed into a rectangular ring of less than one turn, and a third insulator layer containing a ground electrode, wherein a rectangular spiral circuit pattern including the first transmission line and the second transmission line is formed by laminating the plurality of insulator layers to constitute a distributed constant type resonator, and wherein the second transmission line includes a side which is located in parallel with at least one side of the first transmission line, the sides parallel with each other are arranged so as not to overlap in the lamination direction of the plurality of the insulator layers, and at least one corner of at least one of the first transmission line and the second transmission line is formed so that an inner circumference and an outer circumference of the corner are concentric circular arcs.

This way, by using a distributed constant type resonator according to various embodiments of the present invention, a miniaturized filter can be realized.

A filter according to an embodiment is a circuit module that has a plurality of insulator layers including a first insulator layer that contains a first transmission line formed into a rectangular ring of less than one turn, a second insulator layer that contains a second transmission line connected electrically to the first transmission line through an inter-layer connection conductor and formed into a rectangular ring of less than one turn, and a third insulator layer containing a ground electrode, wherein a rectangular spiral circuit pattern including the first transmission line and the second transmission line is formed by laminating the plurality of insulator layers to constitute a distributed constant circuit, and wherein the second transmission line includes a side which is located in parallel with at least one side of the first transmission line, the sides parallel with each other are arranged so as not to overlap in the lamination direction of the plurality of insulator layers, and at least one corner of at least one of the first transmission line and the second transmission line is formed so that an inner circumference and an outer circumference of the corner are concentric circular arcs. This way, the circuit module can be miniaturized.

### Effects of the Invention

In accordance with various embodiments, a small distributed constant circuit, and a filter and a circuit module using such a distributed constant circuit can be provided without deteriorating the frequency characteristics.

### BRIEF DESCRIPTION OF THE DRAWINGS

FIG. 1 is an equivalent circuit diagram showing a filter element according to an embodiment.

FIG. 2 is an exploded schematic perspective view showing a structure of a filter element according to an embodiment.

FIG. 3 is a schematic plan view showing a structure of a filter element according to an embodiment.

FIG. 4 is a schematic cross sectional view of the filter element along the line A-A in FIG. 3.

FIG. 5A is a partially enlarged schematic plan view showing a distributed constant type transmission line 124 according to an embodiment.

FIG. 5B is a schematic cross sectional view of the transmission line 124 along the line X-X in FIG. 5A.

FIG. 6 is a schematic plan view showing another example of a transmission line 124.

FIG. 7 is a schematic plan view showing another example of a transmission line 124.

FIG. 8 is a schematic plan view showing another example of a transmission line 124.

FIG. 9 is a schematic plan view showing another example of a transmission line 124.

FIG. 10 is an enlarged schematic plan view showing a shape of a corner of a transmission line 124. p FIG. 11 is a schematic plan view showing a circuit element according to an embodiment.

FIG. 12 is a graph showing attenuation characteristics of a circuit element according to an embodiment.

FIG. 13 is a graph showing VSWR characteristics of a circuit element according to an embodiment.

FIG. 14 is an exploded schematic perspective view of a structure of another filter element for realizing the equivalent circuit of FIG. 1.

FIG. 15 is a schematic plan view of a structure of a filter element according to an embodiment.

FIG. 16 is a schematic cross sectional view of the filter element along the line B-B in FIG. 15.

FIG. 17 is a graph showing frequency characteristics of a filter element according to an embodiment.

FIG. 18 is an exploded schematic perspective view of a structure of a filter element having a resonator formed linearly.

FIG. 19 is a schematic plan view showing the structure of the filter element of FIG. 18.

FIG. 20 is a cross sectional view of the filter element along the line C-C in FIG. 19.

FIG. 21 is a schematic plan view showing a structure of a filter element having a resonator formed in a meander shape.

FIG. 22 is a schematic cross sectional view of a circuit module having a multilayer wiring substrate including a filter according to an embodiment.

FIG. 23 is a functional block diagram of the circuit module of FIG. 22.

FIG. 24 is an equivalent circuit diagram of a filter according to an embodiment.

FIG. 25 is an equivalent circuit diagram of a filter according to an embodiment.

FIG. 26 is an equivalent circuit diagram of a phase shifter according to an embodiment.

FIG. 27 is a schematic plan view showing a distributed constant type resonator formed in a meander shape.

### DETAILED DESCRIPTION OF EMBODIMENTS

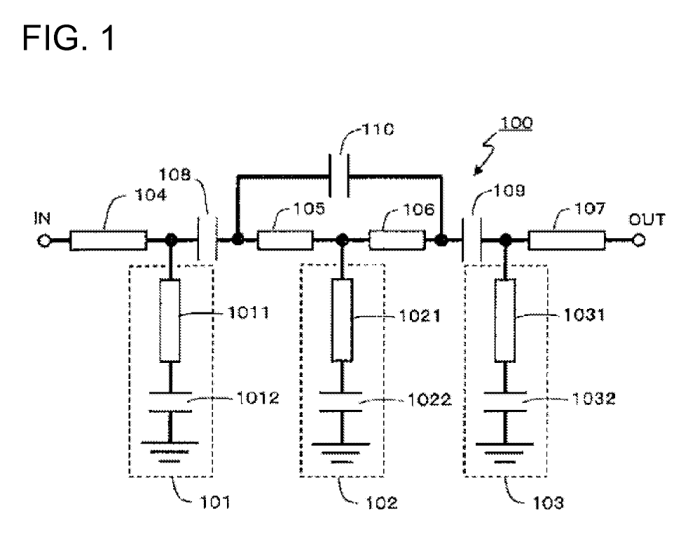

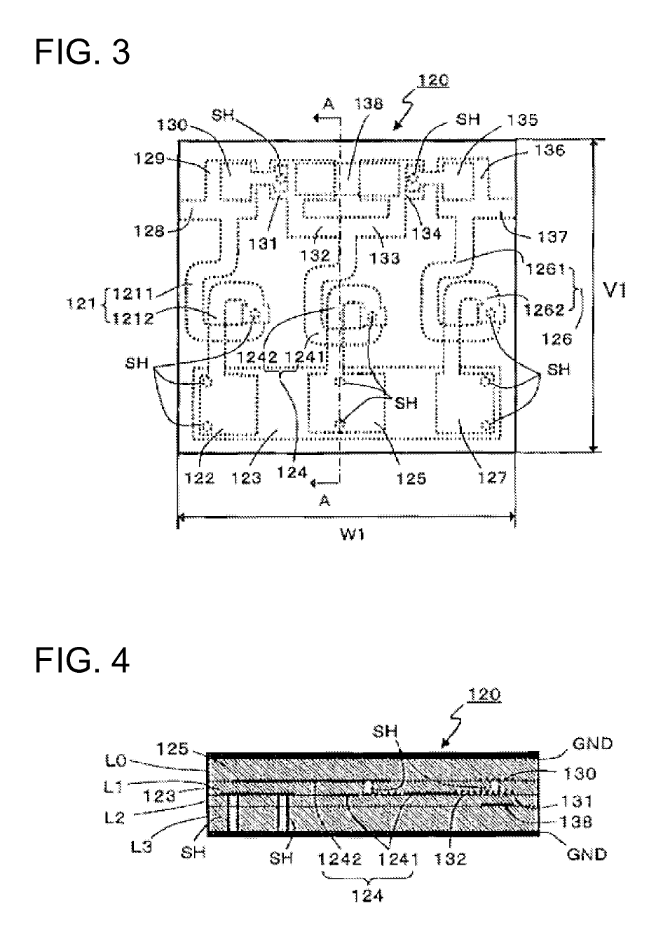

Referring to FIG. 1 through FIG. 4, a distributed constant circuit and a filter element 120 including the distributed constant circuit according to an embodiment of the present invention are described. FIG. 1 shows an equivalent circuit 100 of the filter element 120 according to the embodiment. The equivalent circuit 100 can be used as a small module for a UWB wireless system and is a wide band filter formed using a Low Temperature Co-fired Ceramics (hereinafter referred to as “LTCC”) substrate. The equivalent circuit 100 includes four transmission lines 104-107 connected in series between an input terminal IN and an output terminal OUT, a capacitor 108 connected between the transmission line 104 and the transmission line 105, a capacitor 109 connected between the transmission line 106 and the transmission line 107, a transmission line 1011 having one end connected to a connection point between the transmission line 104 and the capacitor 108, a transmission line 1021 having one end connected to a connection point between the transmission line 105 and the transmission line 106, a transmission line 1031 having one end connected to a connection point between the transmission line 107 and the capacitor 109, a capacitor 1012 connected between the other end of the transmission line 1011 and the ground, a capacitor 1022 connected between the other end of the transmission line 1021 and the ground, a capacitor 1032 connected between the other end of the transmission line 1031 and the ground, and a capacitor 110 connected between an input end of the transmission line 105 and an output end of the transmission line 106. For the transmission lines 1011, 1021, and 1031, the length of a distributed constant line part is determined by considering attenuation pole frequency and matching frequency of a filter. Each of the transmission line 1011, the transmission line 1021, and the transmission line 1031 is an example of the distributed constant circuit according to the embodiment of the present invention.

As described above, in the equivalent circuit 100, a signal line is formed by connecting the four transmission lines 104 to 107 in series between the input terminal IN and the output terminal OUT. Also, the transmission line 1011 and the capacitor 1012 constitute a first resonance circuit 101, the transmission line 1021 and the capacitor 1022 constitute a second resonance circuit 102, and the transmission line 1031 and the capacitor 1032 constitute a third resonance circuit 103. The capacitors 1012, 1022, and 1032 are arranged in order to lower resonance frequencies of the corresponding resonance circuits 101, 102, and 103, and function as shortening capacitors. Thus, by arranging the capacitors 1012, 1022, and 1032, the line lengths of the transmission lines 1011, 1021, and 1031 necessary to realize a predetermined resonance frequency can be shortened.

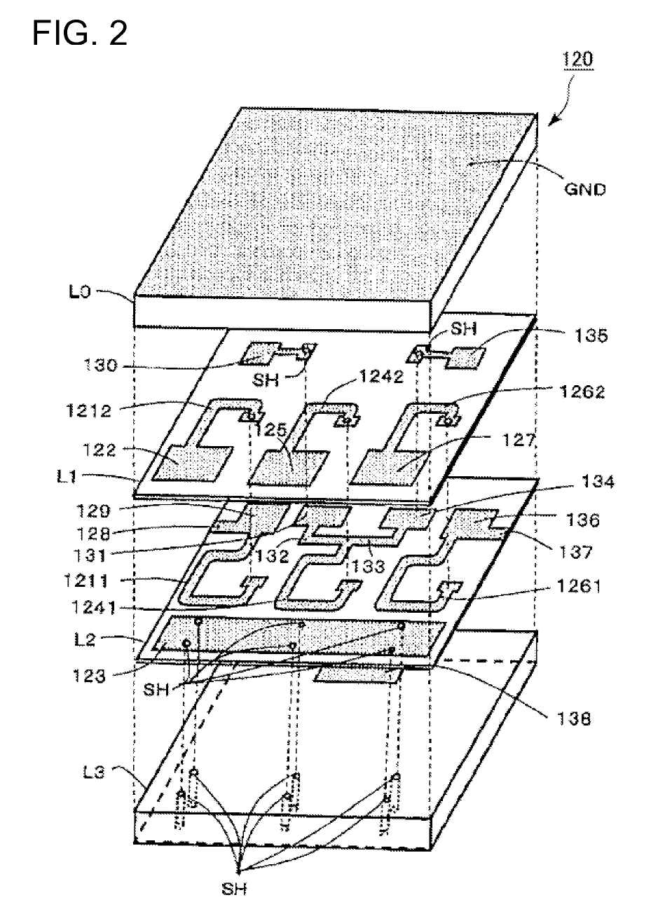

Next, referring to FIG. 2 through FIG. 4, the filter element 120 of the present embodiment is described. The filter element 120 is a circuit element with a multilayer structure to realize the equivalent circuit 100, as shown in FIG. 1. The filter element 120 includes between an insulator layer L0 having a planar ground electrode GND formed on an upper surface and an insulator layer L3 having a planar ground electrode GND formed on an lower surface, an insulator layer L1 having one part of a conductive pattern constituting a distributed constant type resonance circuit of the embodiment formed thereon and an insulator layer L2 having the other parts of the conductive pattern formed thereon. The insulator layer L0 functions as an upper cover, and the insulator layer L3 functions as a lower cover. Therefore, the filter element 120 has a strip line structure having the insulator layers L0 to L3. The insulator layers L0 to L3 are formed of dielectric ceramics with a dielectric constant of, for example, about 5 to 10.

On an input end side of the insulator layer L2, an input side conductive pattern, which includes a lead-out conductor 128 connected to an input terminal, a rectangular capacitor electrode 129 connected to an output end side of the lead-out conductor 128, and a transmission line 1211 extending downward from one side of the capacitor electrode 129, is formed. On the other hand, on an output end side of the insulator layer L2, an output side conductive pattern, which includes a lead-out conductor 137 connected to an output terminal, a rectangular capacitor electrode 136 connected to an input end side of the lead-out conductor 137, and a transmission line 1261 extending downward from one side of the capacitor electrode 136, is formed. Also, between the input side conductive pattern and the output side conductive pattern, a conductive pattern, which includes a pair of capacitor electrodes 131, 134, a transmission line 132 connected to the capacitor electrode 131, a transmission line 133 connected to the capacitor electrode 134, and a transmission line 1241 extending from a connection point of the transmission line 132 and the transmission line 133, is formed. Also, under the transmission lines 1211, 1241, and 1261, a horizontally long capacitor electrode 123 is formed. The capacitor electrode 123 is connected through an inter-layer connection conductor provided in a via hole SH to the ground electrode GND formed on the insulator layer L3.

On an input end side of the insulator layer L1 disposed above the insulator layer L2, a conductive pattern, which includes a transmission line 1212 having one end electrically connected to a via hole SH side end portion (an end portion on the opposite side of the end portion connected to the input terminal) of the transmission line 1211 on the insulator layer L2 through an inter-layer connection conductor provided in the via hole SH, a capacitor electrode 122 disposed to face a part of the capacitor electrode 123 and connected to the other end of the transmission line 1212, and a capacitor electrode 130 disposed to face the capacitor electrode 129, is formed. A resonator 121 is constituted by including the transmission lines 1211 and 1212. On an output end side of the insulator layer L1, a conductive pattern, which includes a transmission line 1262 having one end electrically connected to a via hole SH side end portion of the transmission line 1261 on the insulator layer L2 through an inter-layer connection conductor provided in the via hole SH, a capacitor electrode 127 disposed to face a part of the capacitor electrode 123 and connected to the other end of the transmission line 1262, and a capacitor electrode 135 disposed to face the capacitor electrode 136, is formed. A resonator 126 is constituted by including the transmission lines 1261 and 1262. Also, between the transmission line 1212 and the transmission line 1262, a transmission line 1242 having one end electrically connected to a via hole SH side end portion of the transmission line 1241 on the insulator layer L2 through an inter-layer connection conductor provided in the via hole SH is formed. A resonator 124 is constituted by including the transmission lines 1241 and 1242. A capacitor electrode 125 is connected to the other end of the transmission line 1242 in a position opposing a part of the capacitor electrode 123. Here, the capacitor electrode 122 and the capacitor electrode 123 may be omitted and the part where the capacitor of the transmission line1212 was formed may be connected to the ground electrode GND on the insulator layer L3 through via holes. Similarly, the capacitor electrode 125 or 127 may be omitted and the capacitor electrode 123 may also be omitted, and the part where the capacitor of the transmission line 1242 or 1262 was formed may be connected to the ground electrode GND of the insulator layer L3 through via holes. Thus, any of the capacitor electrodes 122, 125, 127, and 123 may be omitted. Also, the connection between any one of the transmission lines 1212, 1242, and 1262, or all of them, and the ground electrode GND may be omitted so that any one of the transmission lines 1212, 1242, and 1262, or all of them, may be terminated in the insulator layer L1. On the lower surface of the insulator layer L3, a planar ground electrode GND is formed, and a capacitor electrode 138 is formed in a position on the upper surface opposing the capacitor electrodes 131 and 134.

An example of the relationship between respective constituent elements of the filter 120 formed as above and the constituent elements of the equivalent circuit 100 of FIG. 1 is described below. To begin with, with respect to the signal line of the equivalent circuit 100, the transmission line 104 is constituted by the lead-out conductor 128, the transmission line 105 is constituted by the transmission line 132, the transmission line 106 is constituted by the transmission line 133, and the transmission line 107 is constituted by the lead-out conductor 137. The capacitor 108 included in the signal line is constituted by the capacitor electrode 129 and the capacitor electrode 130, and the capacitor 109 is constituted by the capacitor electrode 135 and the capacitor electrode 136. Also, in the resonance circuit 101, the transmission line 1011 is constituted by the transmission line 1211, the transmission line 1212, and the inter-layer connection conductor electrically connecting the transmission line 1211 and the transmission line 1212, and the capacitor 1012 is constituted by the capacitor electrode 122 and the capacitor electrode 123. In the resonance circuit 102, the transmission line 1021 is constituted by the transmission line 1241, the transmission line 1242, and the inter-layer connection conductor electrically connecting the transmission line 1241 and the transmission line 1242, and the capacitor 1022 is constituted by the capacitor electrode 125 and the capacitor electrode 123. In the resonance circuit 103, the transmission line 1031 is constituted by the transmission line 1261, the transmission line 1262, and the inter-layer connection conductor electrically connecting the transmission line 1261 and the transmission line 1262, and the capacitor 1032 is constituted by the capacitor electrode 127 and the capacitor electrode 123. The capacitor 110 is constituted by the capacitor electrodes 131, 134 and the capacitor electrode 138. Thus, the capacitor 110 is composed of two capacitors each connected in parallel with the series circuit of the transmission line 105 and the transmission line 106.

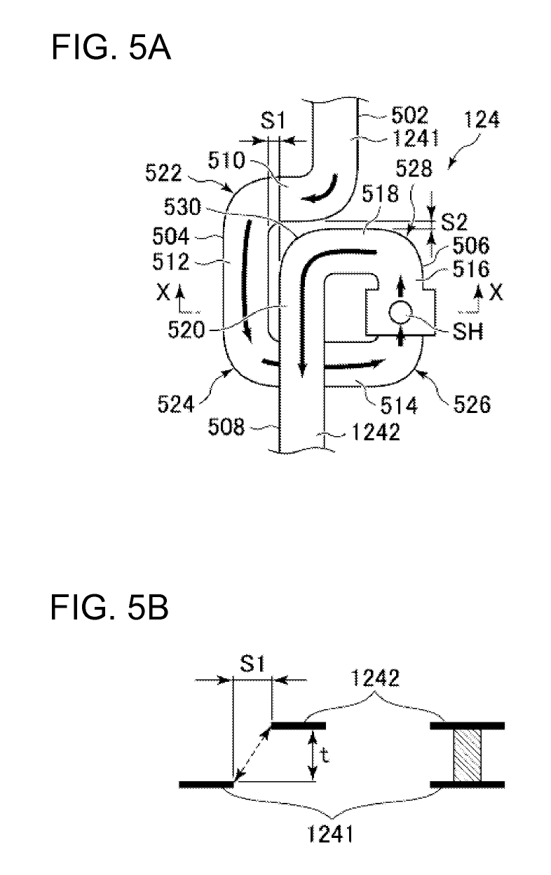

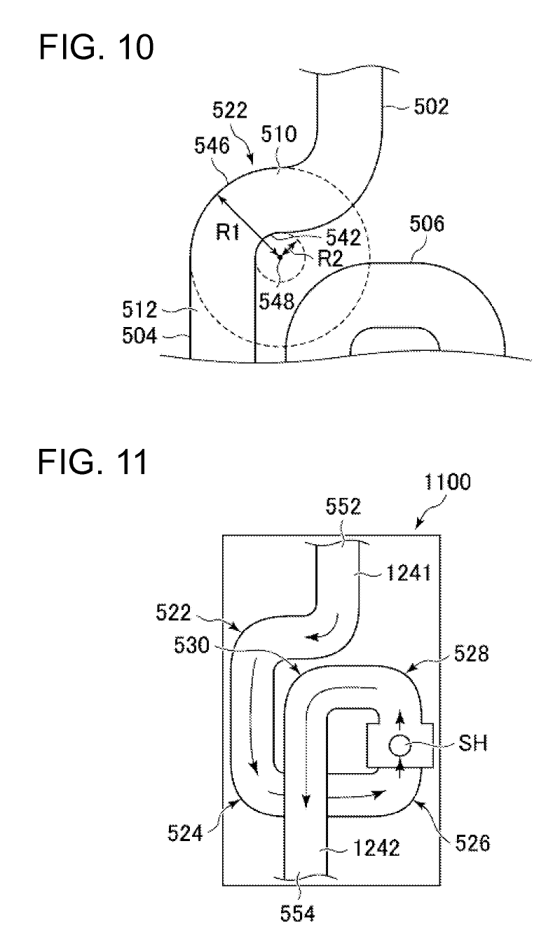

Next, referring to FIG. 5A and FIG. 5B, a distributed constant type resonator according an embodiment is described. FIG. 5A is a partially enlarged view of the distributed constant type resonator 124 of the present embodiment. As described above, the resonator 124 is constituted by the rectangular spiral circuit pattern electrically connecting the transmission line 1241 formed on the insulator layer L2 and the transmission line 1242 formed on the insulator layer L1. The transmission line 1241 is constituted of a linear line element 502 having one end connected to a connection point between the transmission line 132 and the transmission line 133, and a rectangular ring line element 504 circling about 225 degrees from the other end of the line element 502 in the counterclockwise direction, for example. The rectangular ring line element 504 includes sides 510, 512, and 514, a corner 522 connecting the side 510 and the side 512, a corner 524 connecting the side 512 and the side 514, and a corner 526 connecting the side 514 and a via hole SH side end portion of the line element 504. The via hole SH side end portion of the line element 504 is connected to an inter-layer connection conductor provided in the via hole. The inter-layer connection conductor is provided to connect the transmission line formed on the insulator layer L1 and the transmission line formed on the insulator layer L2. On the insulator layer L1, the inter-layer connection conductor is connected to a start point of the transmission line 1242. The transmission line 1242 is constituted of a rectangular ring line element 506 circling about 225 degrees from one end in the counterclockwise direction and a line element 508 extending linearly downward from the other end of the rectangular line element 506. The rectangular ring line element 506 includes sides 516, 518, and 520, a corner 528 connecting the side 516 to the side 518, and a corner 530 connecting the side 518 to the side 520. Each of the corners 522, 524, 526, 528, and 530 is formed so that its inner circumference and outer circumference are concentric circular arcs, as shown in FIG. 10.

The transmission line 1241 is disposed so that respective sides of the rectangular line element 504 are substantially parallel with respective sides of the rectangular line element 506 of the transmission line 1242. For example, the side 510 and the side 514 of the line element 504 are arranged in parallel with the side 518 of the line element 506, and the side 512 of the line element 504 is disposed in parallel with the side 516 and the side 520 of the line element 506. The sides of the line element 504 and the line element 506 that are parallel with each other are arranged so as not to overlap in the lamination direction of the insulator layers L1 and L2. For example, the side 512 and the side 520 are arranged so that they are separated by a distance S1 in the planar direction of the insulator layer L1 or L2. Since the side 520 crosses the side 514 in a substantially perpendicular direction, the sides are partially overlapping with each other. However, the side 520 is arranged so as not to overlap with the side 512 which is arranged in parallel therewith. Even if the perpendicularly crossing sides overlap with each other in the lamination direction, an effect on the characteristics such as stray capacitances and the like is small. Similarly, the side 518 is arranged so that it is separated from the side 510 which is arranged in parallel by a distance S2 in the planar direction of the insulator layer L1 or L2. Thus, the side 518 is arranged so as not to overlap with the side 510 in the lamination direction of the insulator layers L1 and L2. Also, since the transmission line 1241 and the transmission line 1242 are formed on different layers of the insulator layers, as shown in FIG. 5(b), they are formed separated in the thickness direction by a thickness t of the insulator layer L1. In other words, the transmission line 1241 and the transmission line 1242 are arranged so that they are separated not only in the planar direction, but also in the lamination direction of the insulator layers. Since the transmission line 1241 and the transmission line 1242 are arranged in different insulator layers in this way, even if the distance between the transmission line 1241 and the transmission line 1242 in the planar direction of the insulator layers is narrowed, the distance in the lamination direction can be secured. Therefore, the distance in the planar direction of the insulator direction can be made narrower compared with the case where the transmission line 1241 and the transmission line 1242 are formed on one single insulator layer, and miniaturization becomes possible.

Accordingly, the filter 120 of the present embodiment is constituted by laminating the insulator layer L2 having the transmission line 1241 formed thereon including the rectangular line element 504 formed into a rectangular ring of less than one turn, the insulator layer L1 having the transmission line 1242 formed thereon including the rectangular line element 506 connected electrically to the transmission line 1241 and formed into a rectangular ring of less than one turn, and the insulator layers L0, L3 having the ground electrodes. In this laminated configuration, the rectangular spiral circuit pattern including the transmission line 1241 and the transmission line 1242 is formed in the filter 120. Also, at least one side of the rectangular line element 504 is arranged in parallel with one side of the rectangular line element 506, and the sides arranged in parallel are arranged so as not to overlap with each other in the lamination direction of the plurality of insulator layers. By this arrangement, the transmission lines 1241 and 1242 can face the ground electrodes GND on the insulator layers L0, L3 without being substantially obstructed by other conductive patterns. Thus, deterioration of the characteristics by effects from other conductive patterns can be suppressed and the intended design characteristics can be obtained. Since both line elements 504 and 506 are formed into a rectangular ring shape with less than one turn, it is possible to design the lines that have currents flowing in opposite directions to have a large separation distance with each other. Particularly, in comparison with conventional resonators having a transmission line formed in a meander shape or a swirl shape, the lines having currents flowing in opposite directions can have a larger separation distance. For example, the sides facing the rectangular line elements of the transmission line 1241 and the transmission line 1242 (for example, the side 510 and the side 514, or the side 516 and the side 520) have currents flowing in opposing directions. According to the arrangement of the resonator 124 in the present disclosure, by arranging the side 510 at an upper end of a possible placement area of the resonator 124 and by arranging the side 514 at a lower end, the line elements having currents flowing in opposite directions can be arranged to have a large separation. Similarly, for the transmission line 1242, since the line elements having currents flowing in opposite directions can be arranged only in the end portions of the possible placement area, a congested arrangement of the line elements having currents flowing in opposite directions can be avoided. Also, because the transmission lines 1241 and 1242 each are formed in different insulator layers, even if a low resolution screen printing is used, shorting due to bleeding, discharge, or the like can be prevented. The resonators 121 and 126 can be arranged in a manner similar to the resonator 124.

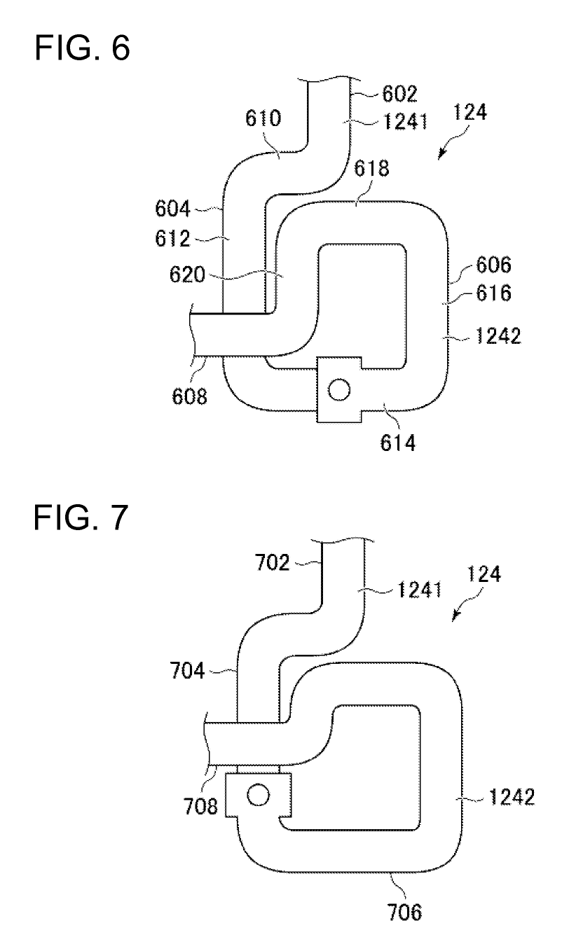

Next, referring to FIG. 6 through FIG. 8, other embodiments of resonators 124 are described. Similar to the resonator of FIG. 5A, the resonators 124, as shown in FIG. 6 through FIG. 8, are constituted in a rectangular spiral shape by electrically connecting a transmission line 1241 arranged on the insulator layer L2 and having a rectangular line element formed into a rectangular ring of less than one turn to a transmission line 1242 arranged on the insulator layer L1 and having a rectangular line element formed into a rectangular ring of less than one turn, through an inter-layer connection conductor. Each corner of the transmission lines included in the resonator 124, as shown in FIG. 6 through 8, is formed so that the inner circumference and the outer circumference are concentric circular arcs, as shown in FIG. 10. In the resonator 124 of the embodiment shown in FIG. 6, the transmission line 1241 is constituted by a linear line element 602 having one end connected to a connection point of the transmission line 132 and the transmission line 133, and by a rectangular ring line element 604 circling about 180 degrees from the other end of the linear line element 602 in the counterclockwise direction. The transmission line 1242 is constituted by a rectangular ring line element 606 circling about 315 degrees from one end in the counterclockwise direction, and by a linear line element 608 extending leftward from the other end of the rectangular line element 606. In the resonator 124 shown in FIG. 7, a transmission line 1241 is constituted by a linear line element 702 having one end connected to a connection point of the transmission line 132 and the transmission line 133, and by a rectangular ring line element 704 circling about 90 degrees from the other end of the linear line element 702 in the counterclockwise direction. A transmission line 1242 is constituted by a rectangular ring line element 706 circling about 315 degrees from one end in the counterclockwise direction, and by a linear line element 708 extending leftward from the other end of the rectangular line element 706. In the resonators 124 shown in FIG. 6 and FIG. 7, since the linear line elements 608, 708 are extended leftward on the insulator layer L1, the arrangement of each of the elements is appropriately adjusted in order to prevent overlapping with the transmission lines constituting the resonator 121.

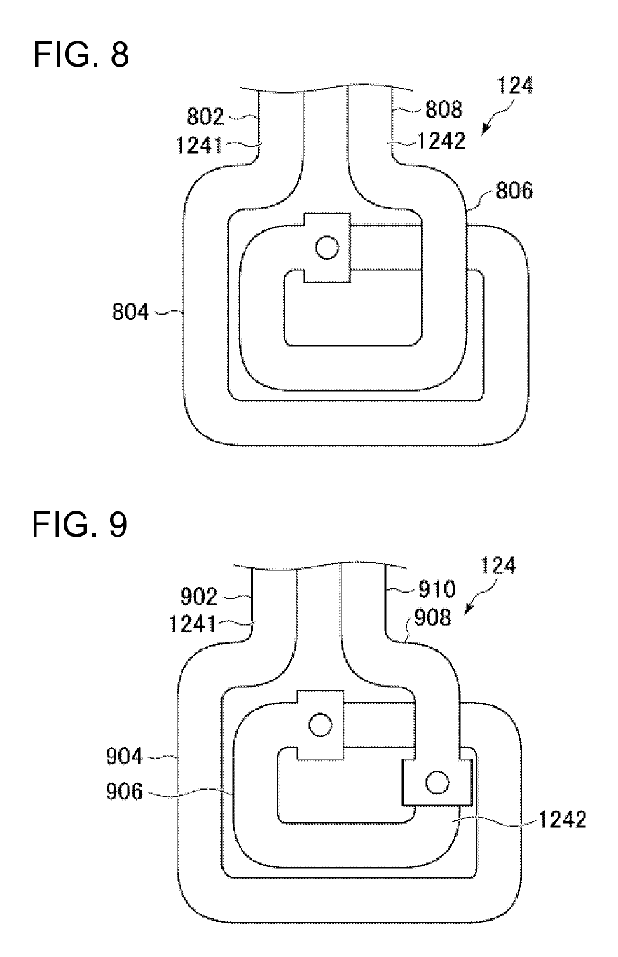

In the resonator 124 shown in FIG. 8, a transmission line 1241 is constituted by a linear line element 802 having one end connected to a connection point of the transmission line 132 and the transmission line 133, and by a rectangular ring line element 804 circling about 315 degrees from the other end of the linear line element 802 in the counterclockwise direction. A transmission line 1242 is constituted by a rectangular ring line element 806 circling about 315 degrees from one end in the counterclockwise direction, and by a linear line element 808 extending upward from the other end of the rectangular line element 806. The resonator 124 shown in FIG. 9 is arranged in such a way that the resonator 124 of FIG. 8 is separated into pieces and arranged in 3 layers of the insulator layers. In the resonator 124 of FIG. 9, a transmission line 1241 is constituted by a linear line element 902 having one end connected to a connection point of the transmission line 132 and the transmission line 133, and by a rectangular ring line element 904 circling about 315 degrees from the other end of the linear line element 902 in the counterclockwise direction. A transmission line 1242 is constituted by a rectangular ring line element 906 circling about 270 degrees from one end in the counterclockwise direction. An insulator layer other than L1 and L2 includes a rectangular ring line element 908 having one end electrically connected through an inter-layer connection conductor to the other end of the rectangular line element 906, and a linear line element 910 extending upward from the other end of the rectangular ring line element 908. The line element 908 is formed into a rectangular ring of less than one turn. In this manner, the resonator 124 can be constituted by connecting transmission lines arranged in three or more layers of the insulator layers. Accordingly, the resonators 124, as shown in FIG. 6 through FIG. 9, are formed into a rectangular spiral circuit pattern by connecting the transmission lines 1241 distributed and arranged in a plurality of insulator layers where each of the transmission lines is formed into a rectangular ring of less than one turn. In addition, at least one side of the rectangular line element arranged in one insulator layer is positioned in parallel with one side of the rectangular line element arranged in the other insulator layer, and the sides arranged in parallel are disposed so that they do not overlap with each other in the lamination direction of the plurality of insulator layers.

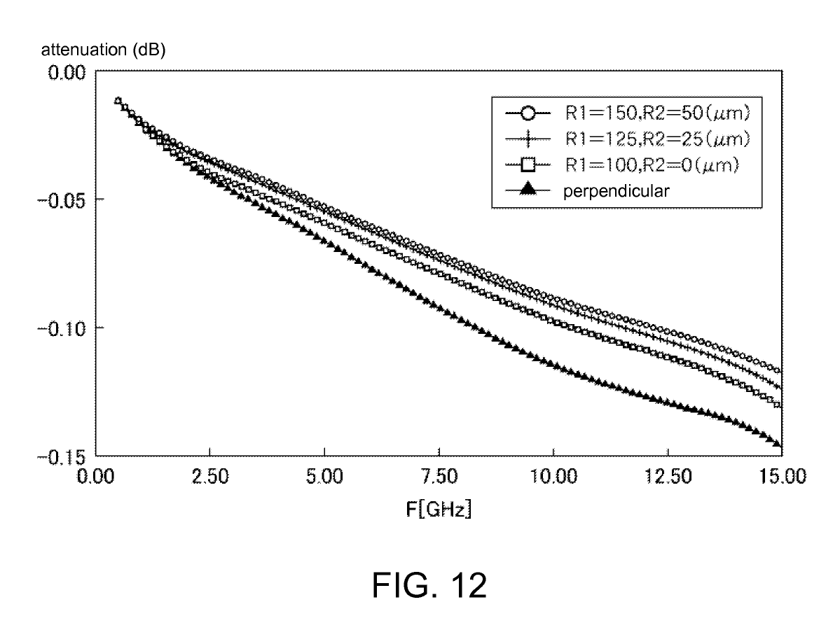

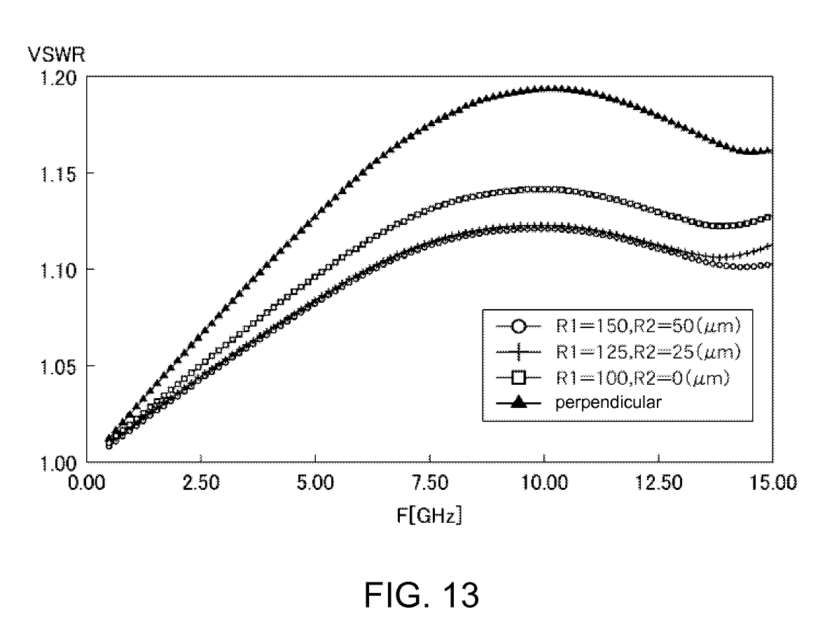

Next, referring to FIG. 10, the structure of respective corners included in the transmission lines 1241 and 1242 is described using a corner 522 as an example. The corner 522 is a corner connecting the side 510 and the side 512 of the line element 504 formed into a rectangular ring shape. The corner 522 is a part of the concentric circles having the center 548 shared by the inner circumference 542 and the outer circumference 546. Each of the concentric circles can be formed to have a variety of radiuses. For example, in the case that the line width of the line element 504 is set to 100 μm (100 micro meter), the radius R1 of the outer circumference may be equal to 150 μm, and the radius R2 of the inner circumference may be equal to 50 μm. Also, the radius R1 of the outer circumference may be 125 μm, and the radius R2 of the inner circumference may be 25 μm, or the radius R1 of the outer circumference may be 100 μm and the radius R2 of the inner circumference may be 0 μm. In the present disclosure, when the outer circumference and the inner circumference are said to be concentric, the case in which the radius R2 of the inner circumference equal to 0 μm is included. The present inventor has conducted a simulation of the transmission characteristics of a resonator line 1100, as shown in FIG. 11, in order to investigate the characteristics of a circuit element having such a corner. Similar to the resonator 124 shown in FIG. 5A, the resonator line 1100, as shown in FIG. 11, is constituted by electrically connecting the transmission line 1241 formed on the insulator layer L2 to the transmission line 1242 formed on the insulator layer L1. Also, by forming the ground electrodes on the insulator layers L0 and L3, a stripline structure is formed. The corners 522, 524, 526 are formed on the transmission line 1241, the corners 528, 530 are formed on the transmission line 1242, and a port 552 on one end portion of the transmission line 1241 and a port 554 on one end portion of the transmission line 1242 are formed. In order to investigate changes in the characteristics due to the radius of the concentric circles, simulation is conducted for each of the following cases: (1) for each corner, the radius R1 of the outer circumference is set to 150 μm and the radius R2 of the inner circumference is set to 50 μm, (2) the radius R1 of the outer circumference is set to 125 μm and the radius R2 of the inner circumference is set to 25 μm, (3) the radius R1 of the outer circumference is set to 100 μm and the radius R2 of the inner circumference is set to 0 μm, and (4) the corner is not formed by concentric circular arcs, but formed as perpendicular. FIG. 12 and FIG. 13 show results of the simulation. In FIG. 12, the horizontal axis indicates frequency in GHz as a unit, and the vertical axis indicates the value of the S parameter (S21) in dB as a unit. In FIG. 13, the horizontal axis indicates frequency in GHz as a unit, and the vertical axis indicates size of the Voltage Standing Wave Ratio (VSWR). As apparent from the results of the simulation depicted in FIG. 12 and FIG. 13, when the corner is formed by concentric circular arcs, attenuation becomes smaller as the radius of the concentric circle increases, and the characteristic impedance can be matched with high precision. Also, when the corner is formed by concentric circular arcs, compared with when formed of perpendicular corners, attenuation can be made smaller remarkably.

The filter element 120, as described above, can be formed by the following method. To begin with, ceramic green sheets are manufactured by mixing powder of LTCC material to be described later, and an organic binder. Next, via holes are formed on a predetermined position of the ceramic green sheet. Following this, a conductive pattern is formed by applying a conductive paste using screen printing on the ceramic green sheet, and the via holes are filled up by the conductive paste. At this time, conductive patterns constituting the transmission lines 1212, 1242, and 1262, and the capacitor electrodes 122, 125, 127, 130, and 135 are formed on the ceramic green sheet corresponding to the insulator layer L1, and a conductive pattern constituting the capacitor electrode 138 is formed on the ceramic green sheet corresponding to the insulator layer L3. In addition, conductive patterns constituting the transmission lines 128, 132, 133, 137, 1211, 1241, and 1261, and the capacitor electrodes 129, 131, 134, 136, and 123 are formed on the ceramic green sheet corresponding to the insulator layer L2. Also, by forming the ground electrodes on the insulator layers L0 and L3, a stripline structure is formed. Further, by laminating these ceramic green sheets, a laminated body is formed. The laminated body is cut into a predetermined size to form an unfired filter element. The filter element 120 having the length V1 and the width W1 is obtained by firing this. The ceramic green sheet can be formed from the LTCC material such as ceramics containing diopside crystal (CaMgSi₂O₆), glass ceramics and the like. Also, the conductive pattern can be formed using a conductive paste having a highly conductive metal such as Ag, Cu, and the like as the main material.

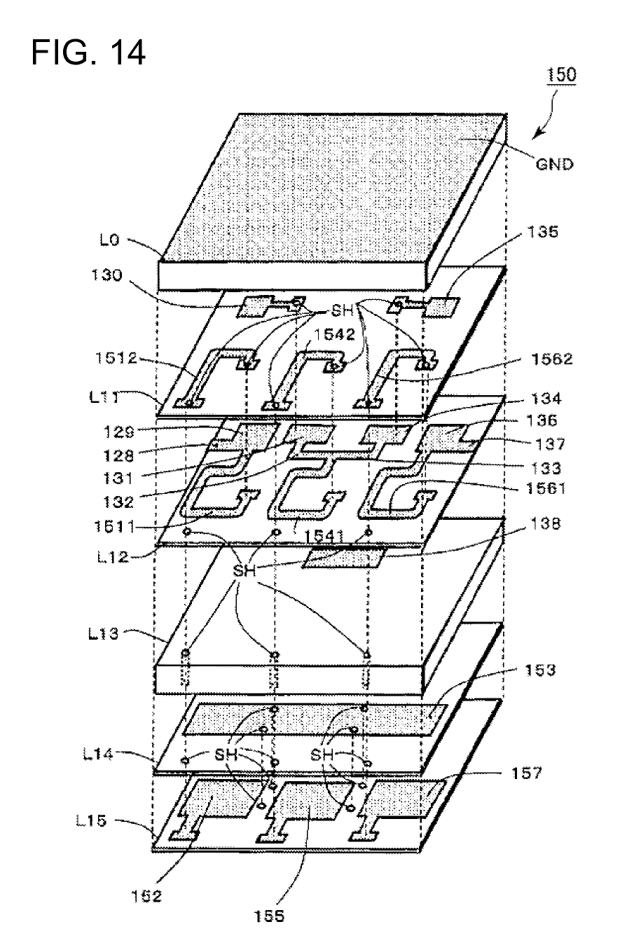

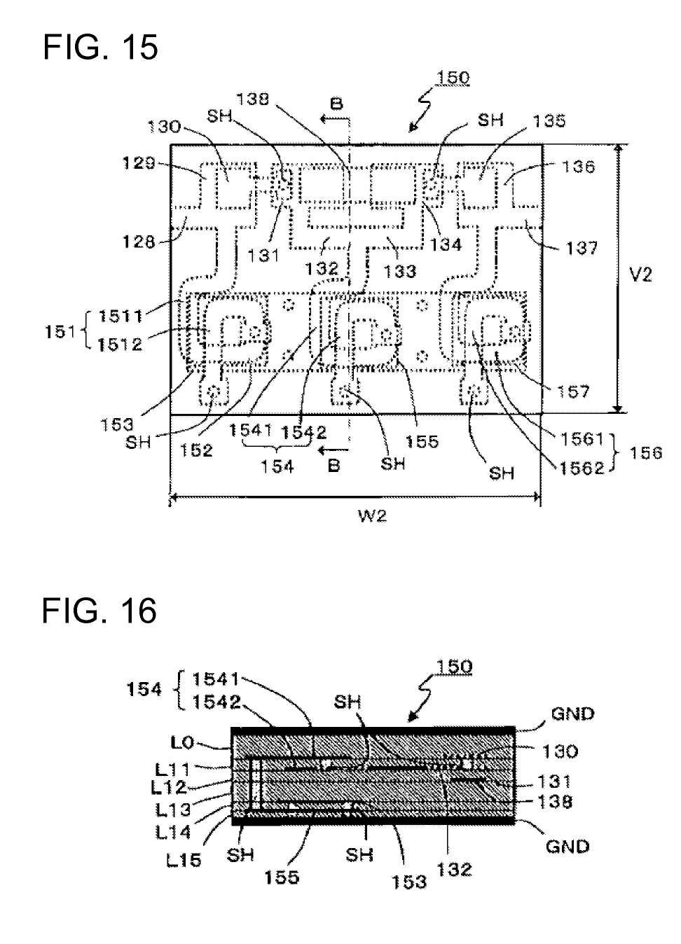

Next, a filter element 150 in another embodiment of the present invention is described by referring to FIG. 14 through FIG. 16. The elements that are common with the elements of the filter element 120 described earlier have been assigned the same reference numerals as the corresponding elements in FIG. 2 through FIG. 4, and their description is omitted. In the filter element 150, the constituents and arrangements of the capacitors 1012, 1022, and 1032 for shortening the wavelength in the equivalent circuit of FIG. 1 are changed, and compared with the embodiments shown in FIG. 2 through FIG. 4, further miniaturization is possible. As shown in FIG. 14 through FIG. 16, the filter element 150 of the embodiment of the present disclosure is constituted by laminating insulator layers L0, L11, L12, L13, L14, and L15. The insulator layers L0, L11, L12, L13, L14, and L15 are formed from a dielectric ceramics with the dielectric constant of, for example, about 5 to 10. The filter element 150 is a circuit element with a multi-layered structure realizing the equivalent circuit 100, as shown in FIG. 1, and is different from the filter element 120 in that the capacitor electrodes that form the capacitors 1012, 1022, and 1032 in the equivalent circuit of FIG. 1 are formed in an insulator layer L15 different from that for the transmission line constituting the resonator.

In the equivalent circuit 100, the resonator 1011 is constituted by a transmission line 1511 and a transmission line 1512, the resonator 1021 is constituted by a transmission line 1541 and a transmission line 1542, and the resonator 1031 is constituted by a transmission line 1561 and a transmission line 1562. In a via hole SH side end portion of the transmission lines 1512, 1542, and 1562, a via hole SH and a terminal connected thereto are each formed. The via hole is also formed on each of the insulator layers L12, L13, L14, and the transmission lines 1512, 1542, and 1562 are electrically connected to respective capacitor electrodes 152, 155, and 157 formed on the insulator layer L15 through an inter-layer connection conductor disposed on these respective via holes SH. On the insulator layer L14, a capacitor electrode 153 is formed in a position facing the capacitor electrodes 152, 155, and 157.

On the insulator layer L13, a capacitor electrode 138 is formed in a position facing capacitor electrodes 131, 134 formed on the insulator layer L12. The capacitor 110 of the equivalent circuit 100 is constituted by the capacitor electrodes 131, 134, and the capacitor electrode 138. On the insulator layer L15, via holes SH are formed between the capacitor electrode 152 and the capacitor electrode 155, and between the capacitor electrode 155 and the capacitor electrode 157. Also, on the insulator layer L14, via holes SH are formed in positions opposing the via holes SH on the insulator layer L15, and the capacitor electrode 153 is electrically connected to a ground electrode GND formed on a lower surface of the insulator layer L15 through inter-layer connection conductors disposed in the via holes SH.

An example of relationship between respective constituent elements of the filter 150 formed as above and the constituent elements of the equivalent circuit 100 of FIG. 1 is described below. To begin with, in the signal line of the equivalent circuit 100, the transmission line 104 is constituted by the lead-out conductor 128, the transmission line 105 is constituted by the transmission line 132, the transmission line 106 is constituted by the transmission line 133, and the transmission line 107 is constituted by the lead-out conductor 137. The capacitor 108 included in the signal line is constituted by the capacitor electrode 129 and the capacitor electrode 130, and the capacitor 109 is constituted by the capacitor electrode 135 and the capacitor electrode 136. Also, in the resonance circuit 101, the transmission line 1011 is constituted by the transmission line 1511, the transmission line 1512, and the inter-layer connection conductor electrically connecting the transmission line 1511 and the transmission line 1512, and the capacitor 1012 is constituted by the capacitor electrode 152 and the capacitor electrode 153. In the resonance circuit 102, the transmission line 1021 is constituted by the transmission line 1541, the transmission line 1542, and the inter-layer connection conductor electrically connecting the transmission line 1541 and the transmission line 1542, and the capacitor 1022 is constituted by the capacitor electrode 155 and the capacitor electrode 153. In the resonance circuit 103, the transmission line 1031 is constituted by the transmission line 1561, the transmission line 1562, and the inter-layer connection conductor electrically connecting the transmission line 1561 and the transmission line 1562, and the capacitor 1032 is constituted by the capacitor electrode 157 and the capacitor electrode 153. The capacitor 110 is constituted by the capacitor electrodes 131, 134 and the capacitor electrode 138.

Resonators 151, 154, and 156 are each arranged in a manner similar to respective resonators 121, 124, and 126 of the filter element 120, as shown in FIG. 2 through FIG. 4.

In the filter element 150, as arranged above, the capacitor electrode 153 is formed in a position receded towards the signal line. Thus, the length V2 of the filter element 150 is shorter by the portion receded by the capacitor electrode 153, when compared with the length V1 of the filter element 120. Accordingly, the filter element 150 can be further miniaturized in the planar direction compared with the filter element 120.

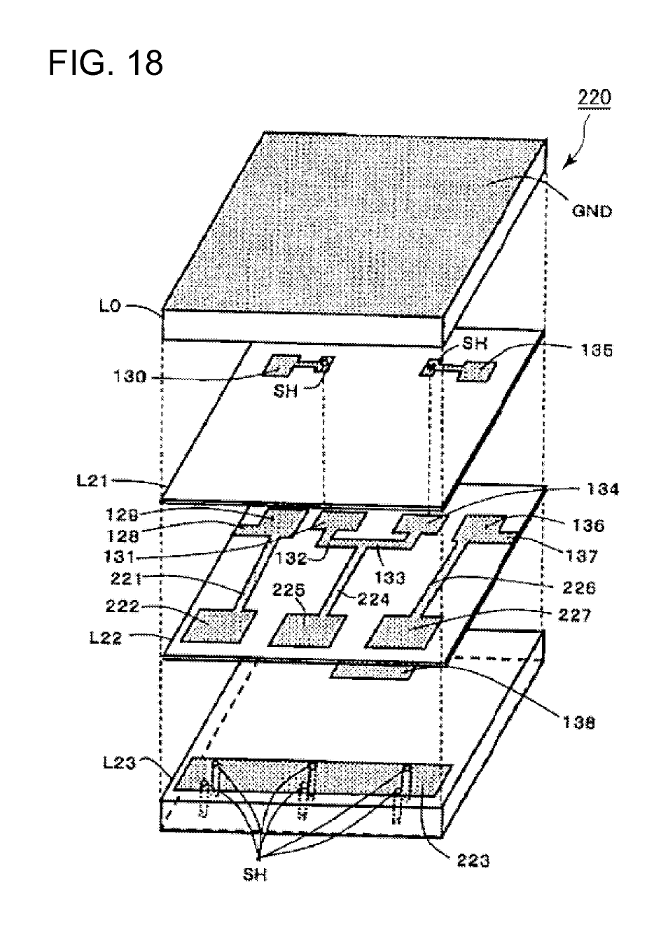

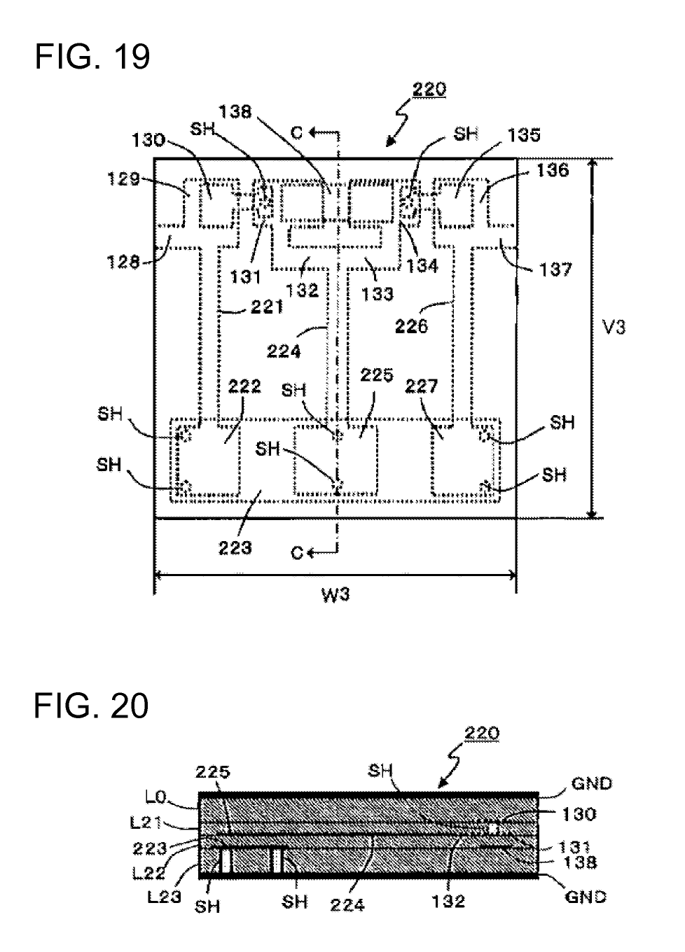

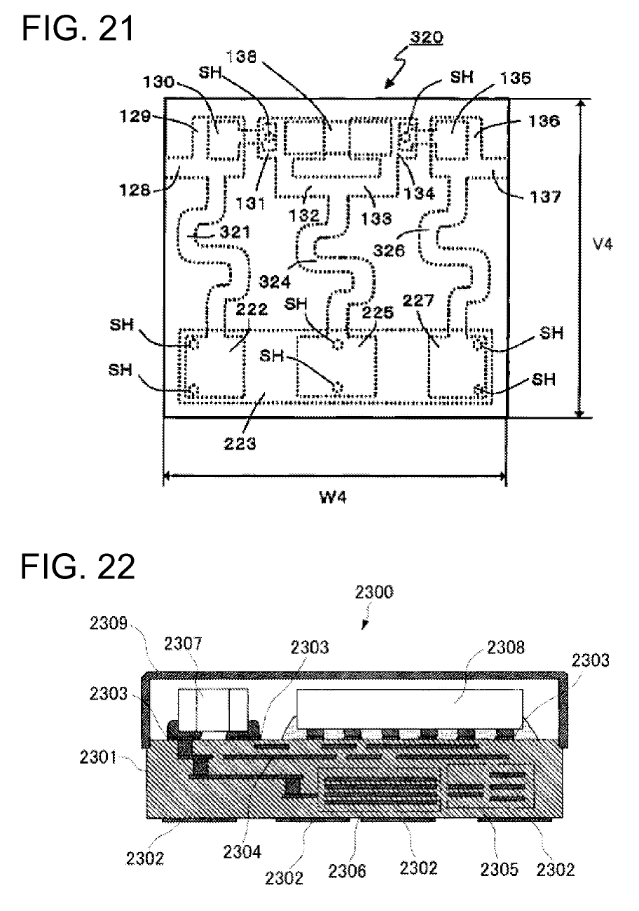

Simulations of the frequency characteristics are conducted, for the filter element 120 of the embodiment shown in FIG. 2, for the filter element 150 of the embodiment shown in FIG. 14, for a filter element 220 shown in FIG. 18 as a comparison example, and for a filter element 320 shown in FIG. 21 as a comparison example. FIG. 18 through FIG. 20 show another example of a filter element having a multilayer structure for realizing the equivalent circuit 100, as shown in FIG. 1. In FIG. 18 through FIG. 20, the constituent elements that are common with the constituent elements shown in FIG. 2 have been assigned the same reference numerals, and their detailed description is omitted. The filter element 220, as shown in FIG. 18 through FIG. 20, is constituted by laminating an insulator layer L0 as an upper cover having a ground electrode GND formed on its upper surface; an insulator layer L21 having an output side capacitor electrode 135 and an input side capacitor electrode 130 formed thereon; an insulator layer L22 having an input side conductive pattern constituted by a lead-out conductor 128, a capacitor electrode 129, a transmission line 221, and a capacitor electrode 222, an output side conductive pattern constituted by a capacitor electrode 136, a lead-out conductor 137, a transmission line 226, and a capacitor electrode 227, and a conductive pattern constituted by a capacitor electrode 131, a transmission line 132, a transmission line 133, a capacitor electrode 134, a transmission line 224 and a capacitor electrode 225, formed thereon; and an insulator layer L23 as an lower cover having a capacitor electrode 138 and a capacitor electrode 223 formed on an upper surface. This filter element 220 is different from the filter element 120 and the filter element 150 each having a resonator formed in a rectangular spiral shape, in that the transmission lines 221, 224 and 226 constituting resonators are formed linearly. FIG. 21 shows a filter element 320 having resonators constituted by meander shaped transmission lines 321, 324, 326. The constituting elements included in the filter element 320 are similar to the filter element 220 except for the meander shaped resonators. The widths W1, W2, W3, and W4 of the filter elements 120, 150, 220, and 320 are equal with each other. On the other hand, since the filter elements 120 and 150 have their resonators formed into a spiral shape, they are smaller than the filer element 220 which has the linear shaped resonators and the filter element 320 which has the meander shaped resonators. Specifically, the lengths V1, V2, V3, and V4 satisfy V3>V4>V1>V2. Also, each of conductive patterns except for those of the distributed constant type resonators are arranged so as to have the same shape and dimension so that the resonance characteristics of each of the distributed constant type resonators are the same.

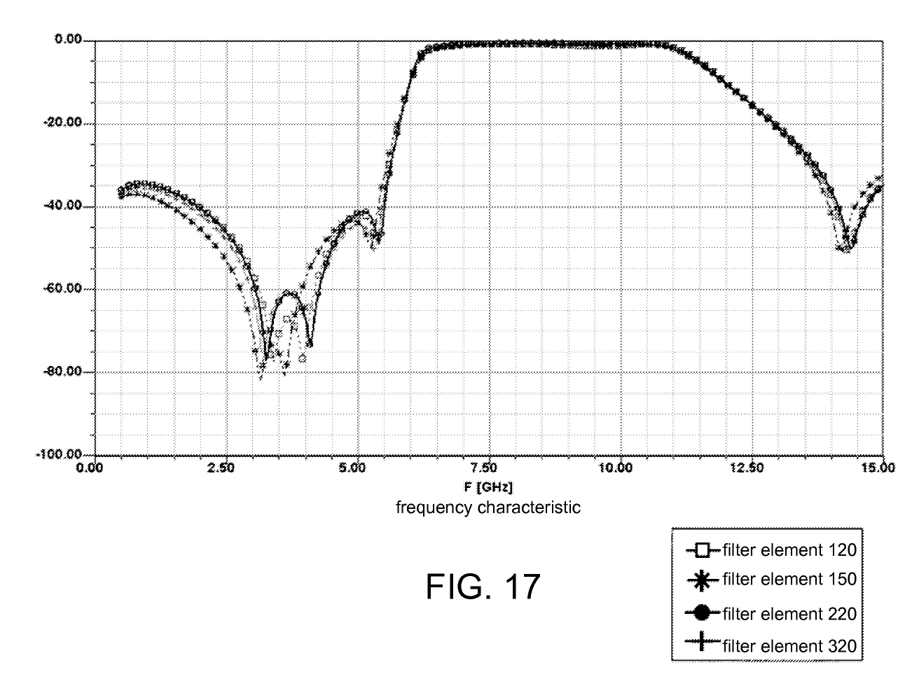

The results of comparing the frequency characteristics of the respective distributed constant type resonators are shown in FIG. 17. From the results shown in FIG. 17, it can be confirmed that the filter element 120 and the filter element 150 having the rectangular spiral shaped distributed constant type resonators can obtain frequency characteristics equivalent to those of the filter element 220 having the linear distributed constant type resonator and the filter element 320 having the meander shaped distributed constant type resonator. Thus, the filter according to each of the embodiments of the present disclosure can realize frequency characteristics equivalent to the filter elements having the linear or meander shaped resonator, while it can be arranged into a small size.

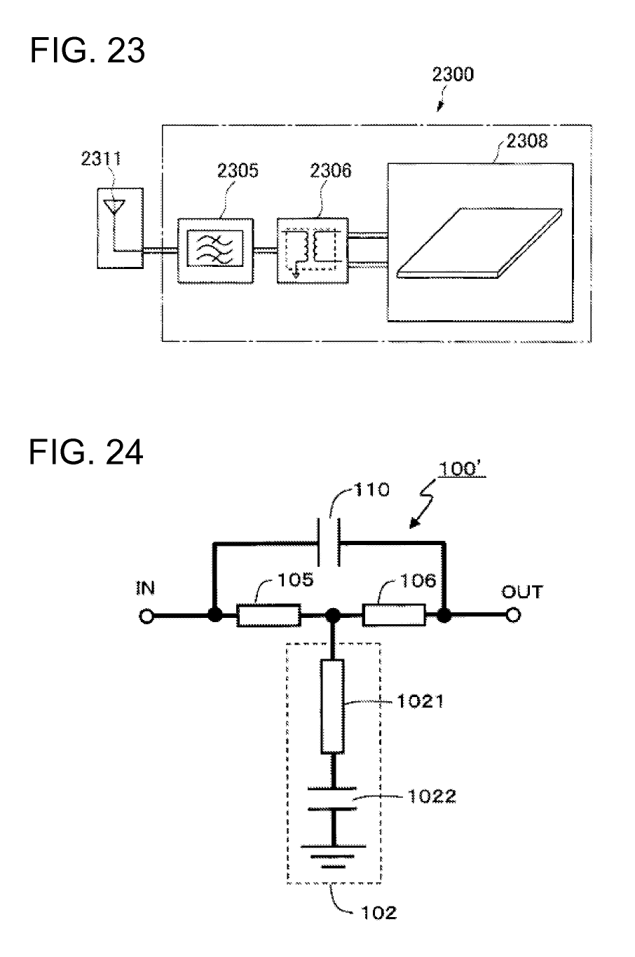

Next, referring to FIG. 22 and FIG. 23, a circuit module 500 using the filter element 120 or the filter element 150 of the present disclosure is described.

As shown in FIG. 22, in the circuit module 2300, an electronic part 2307 such as a chip capacitor or the like, and an individual part such as a high frequency transceiver-use IC 2308 or the like are mounted on a multilayer wiring substrate 2301 through land electrodes 2303. These electronic part 2307 and IC 2308 are covered by a shield cover 2309. On a lower surface of the multilayer wiring substrate 2301, an external terminal electrode 2302 is formed. Inside the multilayer wiring substrate 2301, a wiring conductor 2304, a bandpass filter 2305, and a laminated balun 2306 are built in. The bandpass filter 2305 can be constituted using the filter element 120 or the filter element 150 of the present disclosure.

The multilayer wiring substrate 2301 as described above can be formed following a conventional manufacturing method of a multilayer ceramic device as readily apparent to those having ordinary skill in the art. The filter 2305 formed in the multilayer wiring substrate 2301 is manufactured by printing conductive patterns as well as other wiring conductors on ceramic green sheets by screen printing, forming a laminated body by laminating the green sheets having the conductive patterns printed thereon, and firing it at 850 to 920° C. after having the laminated body at 400 to 700° C. undergo a debinding process.

As shown in FIG. 23, the circuit module 2300 in one embodiment includes an antenna 2311, the bandpass filter 2305, the laminated balun 2306, and the high frequency transceiver-use IC 2308. In the circuit module 2300, wireless signals received by the antenna 2311 are outputted to the bandpass filter 2305. The bandpass filter 2305 passes a signal having a specific frequency among the received signals from the antenna 2311. The signal passed through the bandpass filter 2305 is converted to a balanced signal by the laminated balun 2306 and transmitted to the high frequency transceiver-use IC 2308. The high frequency transceiver-use IC 2308 performs a predetermined receive processing to the received balanced signal.

Thus, according to the embodiments of the present disclosure, a resonator can be miniaturized without degrading the frequency characteristics. Also, by forming a filter element using the miniaturized resonator, a multilayer wiring substrate having the filter element mounted therein and a circuit module having the multilayer wiring substrate mounted therein can be miniaturized.

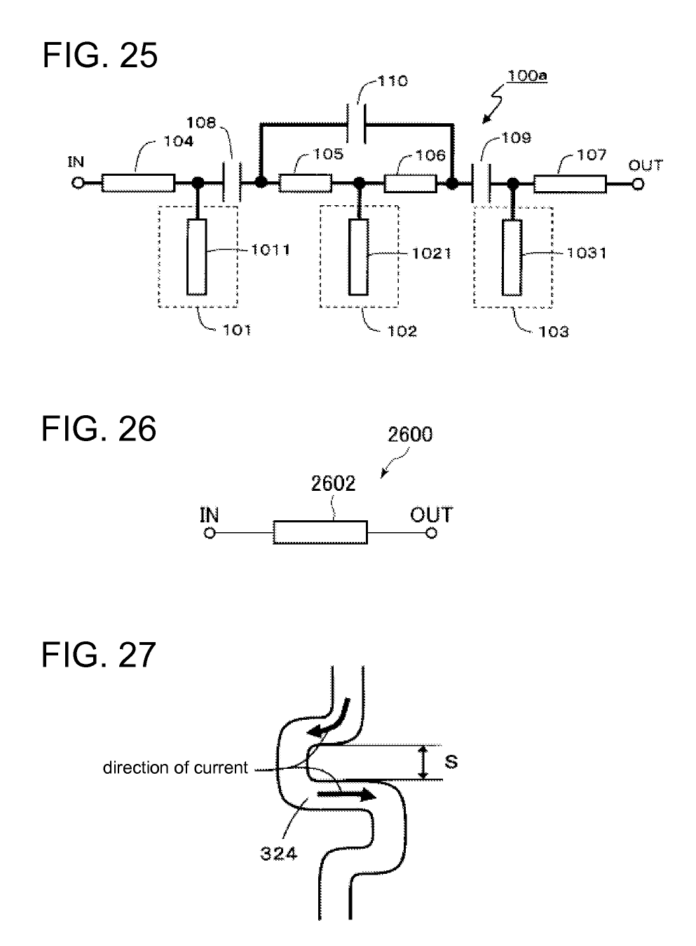

The arrangement of the circuits according to the embodiments of the present invention is not limited to those explicitly disclosed in the present specification, and various changes are possible. For example, in FIG. 1, the equivalent circuit 100 having three resonance circuits is shown. However, a distributed constant circuit in an embodiment of the present invention can be a filter 100′ having one resonance circuit, as shown in FIG. 24. In the filter 100′, the transmission line 1021 is distributed to and arranged on two insulator layers, as shown in FIG. 2 through FIG. 4. On each of the insulator layers, a line element in a rectangular ring shape of less than one turn is formed. The rectangular spiral transmission line 1021 is constituted by electrically connecting these line elements through an inter-layer connection conductor. Also, as shown in FIG. 25, a distributed constant circuit in an embodiment of the present invention can be a filter 100a having open ended resonance circuits. The filter 100a is different from the filter 100 in that the transmission lines 1011, 1021, and 1031 are not grounded through a capacitor. Also, FIG. 26 shows a phase shifter 2600 according to an embodiment of the present invention. The phase shifter 2600 is constituted by connecting one end of the transmission line 2602 to an input terminal and connecting the other end to an output terminal. The transmission line 2602 is a distributed constant circuit according to an embodiment of the present invention, and arranged similarly to the conductive patterns, as shown in FIG. 5A. In other words, the transmission line 2602 is constituted by connecting the transmission lines formed on two or more insulator layers. On each of the insulator layers, a rectangular ring line element of less than one turn is formed. The rectangular spiral transmission line 2602 is constituted by electrically connecting these line elements through an inter-layer connection conductor. Also, in an embodiment, a part realizing the distributed constant circuit of an embodiment of the present invention is embedded in the multilayer circuit substrate 2301. Particularly, a resonator or a filter according to an embodiment of the present invention may be formed in such a substrate. Also, the filter elements 120 and 150 may be formed using a method based on alternately printing a ceramic paste and a conductive paste by screen printing or the like, instead of the method of laminating ceramic green sheets having a conductive pattern formed thereon.

In the filter 120, the transmission lines 1211, 1241, and 1261 may be formed on an insulator layer other than the insulator layer L2, and the transmission lines 1212, 1242, and 1262 may be formed on an insulator layer other than the insulator layer L1. Also, in the filter element 150, the transmission lines 1511, 1541, and 1561 may be formed on an insulator layer other than the insulator layer L12, and the transmission lines 1512, 1542, and 1562 may be formed on an insulator layer other than the insulator layer L11. For a set of the insulator layers L0-L3 and for a set of the insulator layers L0 and L11 through L15 as long as an arrangement realizing the equivalent circuit 100 is adopted, the order of lamination can be changed appropriately. In the present specification, the case of a distributed constant circuit having a stripline structure with ground electrodes formed on the insulator layers L0 and L3 is described, as an example. However, as readily apparent to those having ordinary skill in the art, distributed constant circuits of various embodiments of the present invention may also be formed into a micro stripline structure. In case that a distributed constant circuit is formed into a micro stripline structure, the insulator layer LO is omitted in the filter 120, for example.

This application incorporates by reference in its entirety Japanese Patent Application No. 2005-375484 filed by Taiyo Yuden Co., Ltd. on Dec. 27, 2005, entitled “Resonant Circuit, Filter Circuit, and Multilayered Substrate,” and Japanese Patent Application No. 2009-090814 filed by Taiyo Yuden Co., Ltd. on Apr. 3, 2009, entitled “Distributed Constant Type Resonator, Filter, Multilayer Wiring Substrate, and Circuit Module”.

### DESCRIPTION OF REFERENCE CHARACTERS

100, 100′, 100a filters
120, 150, 220, 320 filter elements
101, 102, 103 resonance circuits
104, 105, 106, 107, 1011, 1021, 1031 transmission lines
108, 109, 110, 1012, 1022, 1032 capacitors
121, 124, 126, 151, 154, 156, 221, 224, 226, 321, 324, 326 resonators
122, 123, 125, 127, 129, 130, 131, 134, 135, 136, 152, 153, 155, 157, 222, 223, 225, 227 capacitor electrodes
128, 137 lead-out conductors
1211, 1241, 1261, 1511, 1541, 1561, 1212, 1242, 1262, 1512, 1542, 1562 transmission lines

1. A distributed constant circuit comprising:
a plurality of insulator layers including:
a first insulator layer that contains a first transmission line including a first rectangular line element formed into a rectangular ring of less than one turn;
a second insulator layer that contains a second transmission line including a second rectangular line element electrically connected to the first transmission line through an inter-layer connection conductor, the second rectangular line element being formed into a rectangular ring of less than one turn; and
a third insulator layer containing a ground electrode,
wherein a rectangular spiral circuit pattern including the first transmission line and the second transmission line is formed by laminating the plurality of insulator layers,
wherein at least one side of the first rectangular line element is disposed in parallel with a side of the second rectangular line element, the sides parallel with each other are arranged so as not to overlap in the lamination direction of the plurality of insulator layers, and at least one corner of at least one of the first transmission line and the second transmission line is formed so that an inner circumference and an outer circumference of the corner are concentric circular arcs.

2. The distributed constant circuit according to claim 1, wherein the first transmission line is connected to an input terminal and the second transmission line is connected to an output terminal.

3. The distributed constant circuit according to claim 1, wherein the first transmission line is connected to an input terminal and to an output terminal.

4. The distributed constant circuit according to claim 3, wherein the second transmission line is grounded.

5. The distributed constant circuit according to claim 3, wherein the second transmission line is grounded through a first capacitor.

6. The distributed constant circuit according to claim 1, further comprising a signal line connecting an input terminal and an output terminal, and a second capacitor connected in parallel with the signal line.

7. The distributed constant circuit according to claim 1, wherein the first transmission line further includes a linearly shaped first linear line element connected to the first rectangular line element.

8. The distributed constant circuit according to claim 1, wherein the second transmission line further includes a linearly shaped second linear line element connected to the second rectangular line element.

9. The distributed constant circuit according to claim 1, further comprising a fourth insulator layer including a ground electrode, wherein the first insulator layer and the second insulator layer are arranged between the third insulator layer and the fourth insulator layer.

10. A filter comprising:
a plurality of insulator layers including:
a first insulator layer that contains a first transmission line connected to an input terminal and to an output terminal and formed into a rectangular ring of less than one turn;
a second insulator layer that contains a second transmission line electrically connected to the first transmission line through an inter-layer connection conductor and formed into a rectangular ring of less than one turn; and
a third insulator layer containing a ground electrode,
wherein a rectangular spiral circuit pattern including the first transmission line and the second transmission line is formed by laminating the plurality of insulator layers to constitute a distributed constant type resonator, and
wherein the second transmission line includes a side which is disposed in parallel with at least one side of the first transmission line, the sides parallel with each other are arranged so as not to overlap in the lamination direction of the plurality of insulator layers, and at least one corner of at least one of the first transmission line and the second transmission line is formed so that an inner circumference and an outer circumference of the corner are concentric circular arcs.

11. A circuit module comprising:
a plurality of insulator layers including:
a first insulator layer that contains a first transmission line formed into a rectangular ring of less than one turn;
a second insulator layer that contains a second transmission line connected electrically to the first transmission line through an inter-layer connection conductor and formed into a rectangular ring of less than one turn; and
a third insulator layer containing a ground electrode,
wherein a rectangular spiral circuit pattern including the first transmission line and the second transmission line is formed by laminating the plurality of insulator layers to constitute a distributed constant circuit, and
wherein the second transmission line includes a side which is disposed in parallel with at least one side of the first transmission line, the sides parallel with each other are arranged so as not to overlap in the lamination direction of the plurality of insulator layers, and at least one corner of at least one of the first transmission line and the second transmission line is formed so that an inner circumference and an outer circumference of the corner are concentric circular arcs.
